(19) United States
(12) Patent Application Publication
(10) Pub. No.: US 2008/0276092 A1
(43) Pub. Date: Nov. 6, 2008

(54) Method for Authentication of Sensor Data, and an Associated Sensor

(76) Inventors: Kurt Eberhardt, Ulm (DE); Peter Stifter, Staig (DE); Karl Hofmann, Ulm (DE); Arnold Erni, Biberach (DE)

Correspondence Address: SCULLY SCOTT MURPHY & PRESSER, PC, 400 GARDEN CITY PLAZA, SUITE 300, GARDEN CITY, NY, 11530, US

(21) Appl. No.: 11/596,425

(22) PCT Filed: May 17, 2005
(86) PCT No.: PCT/DE2005/000915

§ 371 Date: Nov. 10, 2006

(30) Foreign Application Priority Data
May 14, 2004 (DE) 10 2004 024 002.7

(51) Int. Cl. H04L 9/00

(52) U.S. Cl. 713/175

(57) ABSTRACT

A method for authentication of sensor data (D) which is interchanged between at least one sensor (S1 to S4) and an associated receiver (2), in which a request (challenge) is first of all transmitted by the receiver (2) to the at least one sensor (S1 to S4) with an encrypted random number, this request is decrypted by the at least one sensor (S1 to S4), the random number is modified and the modified random number is used as a session key for the subsequent sensor data transmission (response). A first hash value (H) is calculated from the sensor data (D) at the sensor end; a cryptographic checksum (DS) is produced for authentication of the sensor data (D) to be transmitted, a second hash value (H′) is calculated from the first hash value (H) and the session key as a data block and is encrypted using the secret sensor key (GS), the authenticated sensor data (DS+D) is transmitted to the receiver (2), and the authenticity of the cryptographic checksum (DS) is checked at the receiver end.

The invention relates to a method for authentication of sensor data, and an associated sensor.

Sensors are conventionally used in the field of security applications for monitoring of objects and buildings, and for identification of personnel. Many intrusion attempts and attacks take place in order to spoof and to overcome these systems. In the case of modern systems, an interface between the sensor and an associated receiver is generally in the form of an insecure data interface. This is because imaging sensors produce a large amount of data to be transmitted, whose encryption requires considerable computation power. By way of example, the encryption of the video data for transmission of video data thus takes longer than one second, and requires considerable computation power for a software-based implementation. Integration of a microcontroller, as is required for this computation power, in the sensor is technically feasible only with difficulty.

Laid-Open Specification DE 199 63 329 A1 discloses a sensor module having an authentication unit which uses cryptographic methods to protect sensor data to be transmitted. By way of example, in order to protect the sensor data to be transmitted, a hash value is calculated and is encrypted using a secret sensor key (GS), which is used to authenticate the sensor data to be transmitted.

Cryptographic hash functions are mathematical methods which produce or calculate a value of predetermined length in the sense of a checksum (hash value) from any desired data stream (for example sensor data, plain text) using a predetermined method. Hash functions are primarily used to verify the integrity of data and texts.

According to DE 199 63 329 A1, as cited above, the encrypted hash value is decrypted and checked in the receiver. This makes it possible to ensure the source and the integrity of the sensor data. The data detected by the sensor module is preferably consumption data, for example from gas, electricity or water meters etc., or biometric feature data, for example finger lines, whose amount of data is considerably less than that of imaging sensors.

The object of the invention is to specify a method for authentication of sensor data for manipulation-proof data transmission, and to provide an associated sensor.

The invention achieves this object by provision of a method for authentication of sensor data having the features of patent claim 1, and by a sensor having the features of patent claim 5. Advantageous uses of the sensor are claimed by patent claims 8 and 9.

Advantageous embodiments and developments of the invention are specified in the dependent claims.

According to the invention, in order to authenticate the sensor data, the calculation of a cryptographic checksum is linked to a challenge-response method (request-response method), in which this cryptographic checksum is transmitted as authentication data to the receiver, following the sensor data. This advantageously allows the transmitted data to be processed in real time in the receiver, and to be declared as being valid or invalid immediately after the check.

In order to carry out this challenge-response method, a session key is produced between the at least one sensor and the receiver. For this purpose, the at least one sensor receives a request (challenge) from the receiver with an encrypted random number, which the at least one sensor decrypts and modifies using a method which is known at both ends. This modified random number is then sent back as an encrypted data block to the receiver, and represents the response to its request. The receiver, which knows not only the session key but also the secret sensor key (GS), receives this data block, carries out the same modification as the sensor on its original random number, and compares the two numerical values. If the numerical values match, the authenticity of the sensor is verified for the receiver in this transmission session. A session key such as this is valid for only a short time, that is to say for only one session or for one requested data transmission.

A further advantage of the method according to the invention is achieved by the inclusion of the sensor data to be transmitted in the formation of the cryptographic checksum for authentication of the sensor data since this allows the integrity of the transmitted data to be checked. This is because manipulation of the sensor data would result in a changed checksum, which the receiver would identify during the evaluation. The method according to the invention allows a continuous security chain from the sensor, which detects the data, to a central data administration with a secure infrastructure, even if it is publicly known, thus making unidentified manipulation of the transmitted sensor data virtually impossible.

Established standard methods are used for hash-value calculation, that is to say for formation of the cryptographic checksum.

According to one advantageous development of the invention, the hash-value calculation is carried out in parallel with the serial transmission of the sensor data, for which reason this hash value is available as a cryptographic checksum in an advantageous manner directly after the transmission of the sensor data, and can thus easily be attached to the transmitted sensor data, which means that only a small amount of time is required for the encryption process, thus speeding up the overall method.

In order to further speed up the method according to the invention, the sensor data is not all required for the hash-value calculation, but a predetermined number of sensor data items can be used, for example only every third byte. However, this reduces the security of the method, as a function of the amount of sensor data used.

The checking of the received cryptographic checksum is carried out in the receiver by first of all calculating a hash value from the received sensor data, to be precise using the same method with which the second hash value is produced in the sensor, then decrypting the cryptographic checksum, and finally comparing the decryption result with the hash value calculated first of all from the received sensor data, for identity.

A sensor according to the invention has means for production of sensor data, an authentication unit which itself has a checksum generator for production of the cryptographic checksum, and an encryption unit for encryption of the last hash value, that is to say of the second hash value. The sensor is, for example, in the form of an imaging sensor, preferably an infrared camera and/or a digital camera.

In one refinement of the sensor according to the invention, the authentication unit is integrated on the sensor module (sensor chip) and requires an additional chip area of only about 10% for implementation of the method according to the invention. This allows a compact embodiment of the sensor, despite improved manipulation protection.

In one development, the sensor according to the invention is part of a personnel identification system.

In another development, the sensor according to the invention is part of a monitoring system for objects and/or buildings.

One advantageous embodiment of the invention will be described in the following text and is illustrated in the drawings, in which:

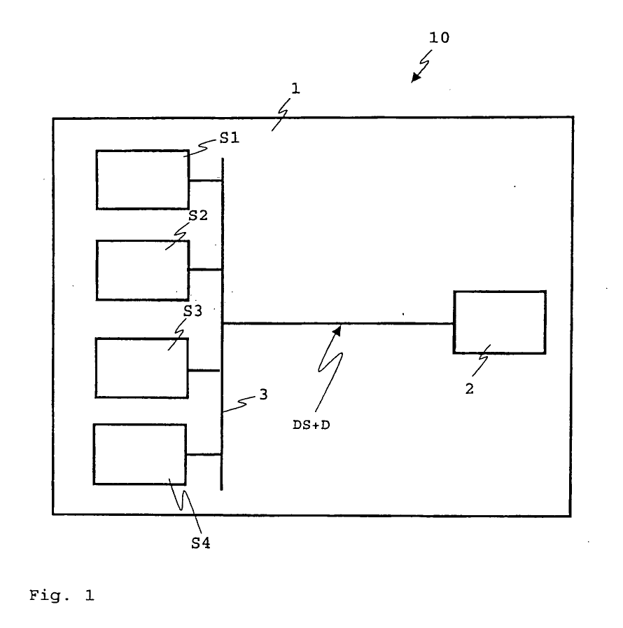

FIG. 1 shows a schematic block diagram of a monitoring system, and

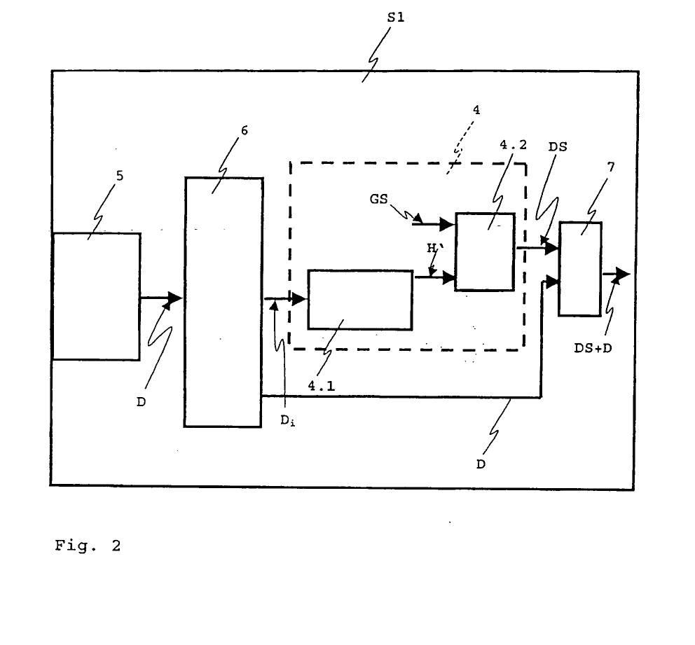

FIG. 2 shows a block diagram of a sensor in the monitoring system shown in FIG. 1.

As can be seen from FIG. 1, a monitoring system 10, for example for a building 1, has a plurality of sensors S1 to S4, which are connected via a bus system 3 to a receiver 2 which, for example, is part of a central data administration, in which the sensor data D transmitted with a cryptographic checksum DS is evaluated and processed. The sensors S1 to S4, which are illustrated by way of example, are preferably in the form of imaging sensors, for example an infrared camera and/or digital camera. Imaging sensors S1 to S4 such as these are used in the field of security applications for monitoring of objects and buildings, and for personnel identification. Many intrusion attempts and attacks take place in order to spoof, to manipulate and to overcome these systems. Such spoofing and/or manipulation attempts must therefore be identified, and an appropriate alarm must be initiated in the receiver 2. In the illustrated monitoring system 10, the method according to the invention is thus used for authentication of sensor data D, as will be described in the following text in conjunction with FIG. 2.

FIG. 2 shows a detailed block diagram of the sensor S1 from FIG. 1, illustrating only those components which are relevant for the invention. As can be seen from FIG. 2, the imaging sensor S1 comprises an image recording means 5, a data processing device 6, an authentication unit 4 with a checksum generator 4.1, and an encryption unit 4.2, and an output control circuit 7.

The image recording means 5 comprises, for example, infrared sensors and/or optical sensors, which record image information from a monitored area, and make this available as sensor data D for further processing and evaluation. In the data processing unit 6, the sensor data D which is provided by the image recording means 5 is read in blocks in order to carry out a block encoding process, that is to say as data blocks Dᵢ each of the same length, into the checksum generator 4.1.

For authentication of the sensor data, the calculation of a cryptographic checksum DS is linked to a challenge-response method (request-response method), with this cryptographic checksum DS being transmitted as authentication data, following the sensor data, to the receiver. For this purpose, the receiver 2 sends a request (challenge) to the sensor S1 to produce a session key, with this request containing an encrypted random number, which is decrypted by the sensor S1 and is modified using a method which is known at both ends.

This modified random number is then sent back to the receiver encrypted as a data block, and represents the response to its request. The receiver, which knows not only the session key but also the secret sensor key GS, receives this cryptographic checksum DS, carries out the same modification as the sensor on its original random number, and compares the two numerical values. If the numerical values match, the authenticity of the sensor is verified for the receiver in this transmission session. A session key such as this is valid for only a short time, that is to say for only one session or for one requested data transmission.

In order to calculate the cryptographic checksum DS, the checksum generator 4.1 first of all determines a first hash value H for the totality of all the data to be transmitted, and then encrypts this, by means of the encryption unit 4.2.

Any established standard method can be used for hash-value calculation. By way of example, however, one method for hash-value calculation will be explained and described in the following text. In this method, which is carried out by means of block encoding, the first hash value H is produced by means of an iteration method from hash values Hᵢ, i=0, 1, . . . N, with a hash value for the i-th iteration being calculated in parallel with the transmission of the sensor data from every i-th data block of the sensor data, which has been subdivided into data blocks Dᵢ, by means of the hash value produced in the previous (i−1)-th iteration.

The checksum generator 4.1 calculates the i-th hash value Hᵢ from the i-th data block by encrypting this using the hash value Hᵢ₋₁ as a key.

A secret sensor key GS, which is stored in the encryption unit 4.2, and/or a value derived from the sensor key, are/is used as the start value H₀ for calculation of the first hash value H₁ for the first data block D₁.

The last iteratively produced hash value H_{N}, as a key with the session key as a data block, is once again subjected to a hash-value calculation in order to produce the second hash value H′. The resultant hash value H′ is supplied to the encryption unit 4.2, where it is encrypted using the secret sensor key GS in order to form the cryptographic checksum DS. The cryptographic checksum DS is transmitted as authentication data with the sensor data D to the receiver 2. This cryptographic checksum DS is thus transmitted directly after complete transmission of a data frame on the same interface, that is to say via the data processing device 6, as DS+D, to the receiver 2.

The output control circuit 7 transmits the sensor data as a data frame via appropriate communication channels which, in the described exemplary embodiment, are in the form of a data bus 3 to the receiver 2, with the cryptographic checksum DS being attached to the end of the sensor data D, which has been combined to form a data group (data frame), so that all the data groups in the sensors are each transmitted with the associated checksum DS to the receiver 2.

The receiver 2 can use a hardware- or software-based calculation to check the authenticity of the received data D from the cryptographic checksum DS, since it knows the key of the transmitting sensor S1 and the session key.

A hash value H′_{E} is thus calculated first of all from the received sensor data D, using the same method for this process as that with which the sensor produces the second hash value. The cryptographic checksum DS is then decrypted, and the decryption result is compared for identity with the hash value calculated first of all from the received sensor data.

Data D from uncertified sensors or without authentication files, that is to say without a checksum, is rejected. If a spoofing and/or manipulation attempt is identified during the checking of the checksum DS, then the receiver 2 initiates an appropriate alarm. Any desired communication channels, that is to say even wire-free transmission methods, may be used for transmission of the data D.

Appropriate session keys are, of course, produced for all of the sensors S1, S2, S3 and S4 using the challenge-response method already described above in order to form a current key for the next data transmission, with these being used as the current key exclusively for the next sensor data transmission between the respective sensor and the receiver 2.

The use of the method according to the invention allows the authentication unit 4 to be integrated on the sensor chip since an additional area of only about 10% is required for this purpose. The described sensors S1 to S4 can thus each be in the form of single-chip assemblies, in which all of the components illustrated in FIG. 2 are integrated on a single chip. This method can also be used for secure data transmission for monolithically integrated sensors which are used in security-relevant systems, for example access controls, border controls, e-commerce etc., in which optical and/or electrical sensors are used, which have a large amount of data.

In the described exemplary embodiment, the sensor according to the invention is part of a monitoring system for objects and/or buildings. Other applications are, of course, also possible, for example in a personnel identification system.

The inclusion according to the invention of the sensor data to be transmitted in the formation of the hash value for the authentication of the sensor data ensures that the integrity of the transmitted data is checked since manipulation of the sensor data would result in a changed checksum, which is identified during the evaluation by the receiver. The method according to the invention is thus also suitable for imaging sensor systems in an unprotected public environment, with the requirement for secure data transmission.

1. A method for the authentication of sensor data (D) which is interchanged between at least one sensor (S1 to S4) and an associated receiver (2), in which a request (challenge) is initially transmitted by the receiver (2) to the at least one sensor (S1 to S4) with an encrypted random number, said request is decrypted by the at least one sensor (S1 to S4), the random number is modified and the modified random number is used as a session key for a subsequent sensor data transmission (response), in accordance with the following steps:
(1) implementing a sensor-end calculation of a first hash value (H) from the sensor data (D),
(2) producing a cryptographic checksum (DS) for an authentication of the sensor data (D) to be transmitted,
a) calculating a second hash value (H′) from the first hash value (H) and utilizing the session key as a data block,
b) encrypting the second hash value (H′) for formation of the checksum (DS) using a secret sensor key (GS),
(3) transmitting the authenticated sensor data (DS+D) to the receiver (2), and
(4) implementing a receiver-end checking of the received cryptographic checksum (DS) for authenticity.

2. The method as claimed in claim 1, in which the first hash value (H) is produced in parallel with the serial transmission of the sensor data.

3. The method as claimed in claim 1, in which only a predetermined number of sensor data items (D) are used for production of the first hash value (H).

4. The method as claimed in claim 1, in which the following steps are carried out in order to check the authenticity of the received cryptographic checksum (DS):
a) implementing a receiver-end calculation of a hash value (H′_{E}) from the received sensor data (D), through the method used in the sensor for calculation of the second hash value (H′),
b) decrypting the received cryptographic checksum (DS), and
c) comparing the decryption result (H′) with the hash value (H′_{E}) for identity.

5. A sensor for carrying out the authentication of sensor data (D) which is interchanged between at least one sensor (S1 to S4) and an associated receiver (2), in which a request (challenge) is initially transmitted by the receiver (2) to the at least one sensor (S1 to S4) with an encrypted random number, said request is decrypted by the at least one sensor (S1 to S4), the random number is modified and the modified random number is used as a session key for a subsequent sensor data transmission (response), said sensor comprising:
means (5) for production of sensor data (D),
an authentication unit (4), and
a checksum generator (4.1), which is arranged in the authentication unit (4), for production of the cryptographic checksum (DS), and an encryption unit (4.2) for encryption of the second hash value (H′).

6. The sensor as claimed in claim 5, which is in the form of an imaging sensor (S1 to S4).

7. The sensor as claimed in claim 5, wherein the authentication unit (4) is integrated on a sensor module.

8. A personnel identification system having at least one imaging sensor (S1 to S4) as claimed in claim 6.

9. A monitoring system for objects and/or buildings, having at least one imaging sensor (S1 to S4) as claimed in claim 6.

10. The sensor as claimed in claim 6, wherein said imaging sensor (S1 to S4) comprises an infrared camera.

11. The sensor as claimed in claim 6, wherein said imaging sensor (S1 to S4) comprises a digital camera.
